(19) United States
(12) Patent Application Publication
(10) Pub. No.: US 2023/0411030 A1
(43) Pub. Date: Dec. 21, 2023

(54) PROCESS FOR THE TREATMENT OF RADIOACTIVE LIQUID SEWAGE AND APPARATUS FOR IMPLEMENTING THE PROCESS

(71) Applicant: Emiliano Caradonna, Monaco (MC)

(72) Inventor: Emiliano Caradonna, Monaco (MC)

(21) Appl. No.: 18/247,509

(22) PCT Filed: Oct. 1, 2021
(86) PCT No.: PCT/EP2021/077173

§ 371 Date: Mar. 31, 2023

(30) Foreign Application Priority Data
Oct. 1, 2020 (WO) PCT/EP2020/077572

(51) Int. Cl. G21F 9/16

(52) U.S. Cl. CPC G21F 9/162; G21F 9/167

(57) ABSTRACT

The present invention is about a process for the treatment of radioactive liquid sewage, deriving from nuclear plants or hospital waste containing various metals, non-metals and organic compounds, in order to transform this sewage into a vitreous body safely retaining the nuclear elements or isotopes in a silica matrix; the invention also regards an apparatus for implementing the process in an automated way.

### FIELD OF THE INVENTION

The present invention is about a process for the treatment of radioactive liquid sewage, deriving from nuclear plants or hospital waste containing various metals, non-metals and organic compounds, in order to transform this sewage into a vitreous body safely retaining the nuclear elements or isotopes in a silica matrix; the invention also regards an apparatus for implementing the process in an automated way.

### STATE OF THE ART

Radioactive by-products, residues or waste of human activities are generally referred to as “nuclear wastes”. Owing to its hazardousness for humans and the environment, nuclear wastes of any type and origin must be treated and stored according to special procedures, which ensure that the radiation and nuclear elements or isotopes are confined for very long periods of time.

There are numerous types of activities and processes that produce waste at various levels of concentration and hazardousness. Medical materials used in nuclear medicine, disposable clothing supplied during a visit to a nuclear plant or other sources of waste with a low level of radioactivity represent the largest category, comprising about 90% by weight of the radioactive waste produced, but only 1% of the radioactivity; waste with a medium level of radioactivity, such as the sheaths of the fuel elements used in nuclear plants constitutes about 7% by weight of the waste, with a total radioactivity of 4%; finally, wastes with a high level of radioactivity (for instance, nuclear sludges or waste from reclamation or “decommissioning” of nuclear reactors that are no longer active) constitutes only 3% of the radioactive waste but accounts for 95% of the radioactivity, and are the most dangerous ones owing to the high radiation dose transferred upon accidental exposure and to the decay time in the order of millions of years for some of the radioactive isotopes they contain.

Most of the cited activities produce wastes in the form of ashes, slurries, muds, sludges, solutions, or dispersions containing metallic ions, that have to be disposed of in a safe way. A description of the problems involved in disposing of wastes from nuclear plants, reference can be made to the article “Nuclear Fuel Recycling: More Trouble Than It's Worth”, Frank N. von Hippel, Scientific American, April 2008.

A typical composition of radioactive sludge coming from nuclear plants is reported in the table below:

| Substance | Units | Up to |
|---|---|---|
| Total solids | g/kg | 300 |
| Non-dissolved solids | g/kg | 50 |
| Boron | mmol/kg | 1000 |
| Chlorides | mmol/kg | 100 |
| Nitrates | mmol/kg | 100 |
| Phosphates | mmol/kg | 600 |
| Sulfates | mmol/kg | 100 |
| Magnesium | mmol/kg | 40 |
| Aluminum | mmol/kg | 1000 |
| Silicon | mmol/kg | 1000 |
| Sodium | mmol/kg | 2300 |
| Potassium | mmol/kg | 100 |
| Calcium | mmol/kg | 45 |
| Titanium | mmol/kg | 2 |
| Chromium | mmol/kg | 4 |
| Iron | mmol/kg | 200 |
| Cobalt | mmol/kg | 4 |
| Nickel | mmol/kg | 4 |
| Copper | mmol/kg | 2 |
| Zinc | mmol/kg | 100 |
| Molybdenum | mmol/kg | 1 |
| Tin | mmol/kg | 1 |
| Barium | mmol/kg | 1 |
| Lead | mmol/kg | 3 |

The disposal of these wastes generally requires a phase of conditioning, which consists in inertization of the waste and its transformation into a form suitable for storage; and storage of the conditioned waste at suitable sites, either natural or produced industrially.

Many techniques have been described for the conditioning of nuclear waste.

Some studies concentrated on the use of iron-containing phosphate vitreous systems as a host for radioactive isotopes; systems of this type are described in U.S. Pat. Nos. 5,750,824 and 5,840,638 and in patent application GB 2,371,542 A.

Another class of materials evaluated for fixing radioactive isotopes are the silica-based glasses; see for example the article “Glass packages guaranteed for millions of years”, by É. Y. Vernaz, Clefs CEA, No. 46 (2002), p. 81-84.

One technique proposed for producing silica based vitreous bodies it sol-gel.

The sol-gel technique is widely known in chemistry, and consists in hydrolyzing a compound or mixture of compounds of one or more three-valent or tetra-valent metal or metalloid in a aqueous or hydro-alcoholic solution (the sol), forming compounds in which one or more groups linked to the metal or metalloid are hydroxy groups, and causing the hydroxide species thus formed to react by condensation (i.e., elimination of a water molecule and formation of an oxygen bridge between two metal or metalloid atoms), forming a 3D network of bonds coextensive with the starting sol, and containing the solvent (the gel). The preferred element for forming gels following this route is silicon. The wet gel thus obtained may then be allowed to dry naturally, possibly in an oven, or supercritically dried obtaining a porous solid body; a dry gel obtained by drying in air (with heating or not) is called in the field a “xerogel”, while a dry gel obtained by supercritical drying is called an “aerogel”. Natural drying (leading to xerogels) may give rise to breakings in the dry gel and consequently in the final vitreous body; the tendency to breaking in xerogels increases with increasing size. Supercritical drying of wet gels ensures that the dry gel and the final vitreous body do not break, but this route, when applied to wet gels obtained from aqueous or hydro-alcoholic solutions, requires dedicated equipment (autoclaves), temperatures between 240° C. (ethanol, an alcohol typically employed in sol-gel processes) and 370° C. (water), and pressures between about 60 bar (ethanol) and 217 bar (water); adopting this drying route is thus only justified if there is the absolute need to obtain an integer final piece that exactly replicates the shape of the starting wet gel, but is not generally suitable for a large-scale industrial application. A dry gel can finally be compacted by means of a thermal treatment (step called “sintering” in the field), generally at temperatures above 1000° C. In the starting sol, it is possible to add other components that would not themselves be capable of forming a gel but may be picked up in the network of bonds of the gel-forming element, resulting thus incorporated in the final wet gel and in the final porous or dense solid body when the wet gel is submitted to drying and possible subsequent sintering.

This approach to the fixing of nuclear elements or isotopes has been exploited in several patent documents, such as U.S. Pat. Nos. 4,514,329 and 5,494,863, and in patent applications EP 1667938 A1 and WO 2010/043698 A2.

Despite the progress achieved, it is still felt in this field the need of an efficient process for the immobilization of nuclear isotopes in vitreous bodies.

It is thus an object of the present invention to provide a process for the treatment of radioactive liquid sewage, that makes it possible to fix the radioactive elements and isotopes in solid articles of long-term stability; another object of the invention is to provide an apparatus implementing the process in an automated way.

### SUMMARY OF THE INVENTION

These objects are achieved with the present invention that, in a first aspect thereof, consists in a sol-gel process for the treatment of radioactive liquid sewage that allows to immobilize radioactive elements and/or isotopes initially present in said sewage in solid vitreous bodies, which comprises the following steps:
a) preparing a dispersion in water of silica in the form of finely subdivided particles, having size lower than 100 μm, with a silica concentration between 10 and 90% by weight, controlling the pH of the dispersion at a value of 4 or lower by addition of an acid;
b) adding to the dispersion prepared in step a) an alkoxysilane, compound of general formula Si(OR)₄ wherein R is a linear or branched C1-C4 alkyl radical, in a molar ratio alkoxysilane/silica between 0.4 and 0.7;
c) at the end of the hydrolysis reaction, feeding the dispersion of step b) to a mixer provided with a stirring system, a pH-meter and an outlet nozzle, along with a radioactive liquid sewage, controlling the mixing ratio to such a value that the resulting mixture has a pH value above 4.8;
d) dispensing the mixture obtained in step c) through the outlet nozzle into one or more molds or on a flat surface;
e) drying the mixture by placing the molds containing it in an oven at a temperature of between 60 and 70° C. for at least 48 hours, obtaining one or more dry porous gel bodies;
f) treating the dry porous gel bodies obtained in step e) at a temperature between 850 and 1350° C., obtaining one or more vitreous bodies consisting of a silica matrix embedding the radioactive elements and/or isotopes.

In a variant of the process described above, the overall amount of alkoxysilane required for the reaction may be added partly to the dispersion of silica in water of step a), and partly to the radioactive liquid sewage used in step c).

In another variant of the process, the dispersion of silica in water of step a) and the radioactive liquid sewage are first mixed, and the whole amount of alkoxysilane employed in the reaction is added to the mixture thus obtained.

In a second aspect, the invention regards an apparatus that can implement the process above in an automated way, comprising:
a tank for a dispersion of silica in water, positioned on a balance;
a reservoir for an alkoxysilane;
a tank provided with a mixing device for a mixture of the dispersion of silica in water and the alkoxysilane;
pipes connecting the tank for the dispersion of silica in water and the reservoir for the alkoxysilane to the tank for the mixture of dispersion of silica in water and alkoxysilane;
a volumetric valve on the pipe connecting the reservoir for the alkoxysilane to the tank for the mixture of dispersion of silica in water and alkoxysilane;
a volumetric valve on the pipe connecting the tank for the dispersion of silica in water to the tank for the mixture of dispersion of silica in water and alkoxysilane;
a thermometer inserted in the tank for the mixture of dispersion of silica in water and alkoxysilane;
a reservoir for a radioactive liquid sewage, positioned on a balance;
a stirred tank for the radioactive liquid sewage;
a pipe connecting the reservoir for the radioactive liquid sewage to the stirred tank for said sewage;
a mixing tank or device for mixing said dispersion of silica in water and alkoxysilane and said radioactive liquid sewage;
a pipe connecting the tank containing the mixture of dispersion of silica in water and alkoxysilane to said mixing tank or device;
a pipe connecting said stirred tank for sewage to said mixing tank or device;
a microprocessor or a personal computer;
means, controlled by said microprocessor or personal computer, for mixing said dispersion of silica in water and alkoxysilane and said radioactive liquid sewage controlling that the resulting mixture has a preset pH value
an electrical/data line connecting to said microprocessor or personal computer the volumetric valve on the pipe connecting the reservoir for the alkoxysilane to the tank for the mixture of dispersion of silica in water and alkoxysilane;
an electrical/data line connecting to said microprocessor or personal computer the volumetric connecting the tank for the dispersion of silica in water to the tank for the mixture of dispersion of silica in water and alkoxysilane;
an electrical/data line connecting said thermometer to said microprocessor or personal computer;
a conveyor belt for transporting the mixture leaving said mixing tank or device, either in molds or directly on the surface of the belt, in an oven.

### BRIEF DESCRIPTION OF THE DRAWINGS

FIGS. 1 to 3 show schematic representations of possible embodiments of the apparatus of the invention;

FIG. 4 shows a possible thermal treatment profile according to the invention for vitrifying a dry gel.

### DETAILED DESCRIPTION OF THE INVENTION

In its first aspect, the invention consists in the sol-gel process for immobilizing radioactive elements and/or isotopes.

As indicated above, the process admits three variants, depending on the solution and time of the process in which the addition of the alkoxysilane takes place. The process is described below with reference to the first variant, comprising steps a)-f) defined above; the experts in the field will have no difficulty in modifying this process so to carry it out according to the second and third variants.

The first step of the process, step a), consists in preparing a dispersion in water of silica powders having particle size less than 100 μm, in which silica has a concentration between 10 and 90% by weight, while controlling that the pH of the dispersion constantly remains at a value of 4 or lower by addition of an acid.

Preferably, the dispersion has a content of silica between 20 and 65% by weight, and more preferably between 30 and 40% by weight. Silica can be any form of silica powders having particle size less than 100 μm; preferably, said silica powders have particle sizes lower than 10 μm, and even more preferably lower than 5 μm. The preferred kind of silica is the so-called “fumed silica” or “pyrogenic silica”, a highly dispersed and highly porous form of silica obtained from combustion of SiCl₄ with oxygen. Fumed silica is commercially available from various producers; an example is Aerosil® OX 50 produced and sold by Evonik Resource Efficiency GmbH (Germany; Aerosil is a registered trademark of Evonik). The addition of silica to water is preferably carried out under vigorous agitation, for instance using a disperser of the series IKA® UltraTurrax® (registered trademarks of IKA-Werke GmbH & Co. KG) or similar devices.

The addition of silica to water to form the dispersion is carried out under constant control of pH, to ensure that this never exceeds 4; preferably, the pH of the dispersion in this step is kept in the range from 1.5 to 3, and more preferably from 2 to 2.5. The pH of the dispersion is kept in the desired range by addition of an acid; this may be an organic acid such as formic acid or acetic acid, but preferably an inorganic acid is used, such as hydrochloric acid, nitric acid, phosphoric acid, or sulfuric acid.

Step a) of the process is carried out at room temperature, that is, with no cooling or heating of the system, thus typically at a temperature in the range between 18 and 30° C.

In step b), to the silica dispersion thus obtained is added an alkoxysilane in a molar ratio alkoxysilane/silica between 0.4 and 0.7. Alkoxysilanes are compounds of general formula Si(OR)₄ wherein R is a linear or branched C1-C4 alkyl radical; the preferred alkoxysilanes for use in the present invention are tetramethylortosilane, Si(OCH₃)₄, generally referred to in the field as “TMOS”, and particularly, tetraethylortosilane, Si(OCH₂CH₃)₄, generally referred to in the field as “TEOS”. The preferred molar ratio alkoxysilane/silica is between 0.5 and 0.6; for instance, in a preferred recipe according to the invention, 2 liters of TEOS are added to a dispersion prepared with a 1 kg of fumed silica. The alkoxysilane is hydrolyzed by water, according to the reaction:

Si(OR)₄+4H₂O→Si(OH)₄+4ROH

This reaction gives rise to an increase in temperature, that rapidly reaches a value between 35 and 45° C., depending on the ratio alkoxysilane/water, which in turn depends on the concentration of silica in the dispersion of step a). The end of the hydrolysis reaction is indicated by the decrease of temperature.

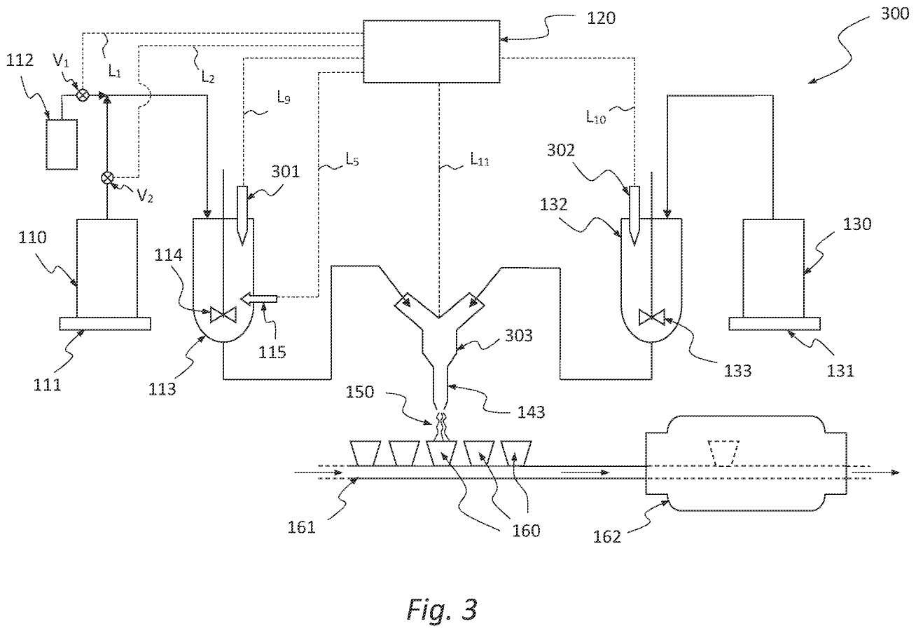

When the alkoxysilane hydrolysis of step b) is over, step c) of the process is carried out. In this step, the dispersion of step b) is fed to a mixer provided with a stirring system, a pH-meter and an outlet nozzle, to which is simultaneously fed a radioactive liquid sewage. In an alternative embodiment, in which the pH values of the dispersion of step b) and of the radioactive liquid sewage are measured separately, these two liquid phases are fed to a mixing device not equipped with a pH-meter; this possibility is illustrated more in detail below with reference to the operation of the apparatus of FIG. 3. The mixing ratio of the two liquid phases must be such that the resulting mixture has a pH value above 4.8. The mixer must be efficient enough to very rapidly mix the two liquid phases during the co-addition into the mixer tank, in order to ensure that the resulting mixture has constantly a homogeneous composition (or nearly so); this condition is necessary for the obtainment of a homogeneous distribution of radioactive elements and/or isotopes in the gel network and in the final vitreous body, so that these elements and/or isotopes are efficiently fixed in the 3D network of bonds of the silica phase; if, on the contrary, mixing is not efficient during this step of the process, the result could be the formation of a silica phase embedding “bubbles” of radioactive liquid sewage in which said elements and/or isotopes are poorly bonded, and could be easily released from the final glass.

Radioactive liquid sewages have typically pH values in the range between 5 and 14, so are normally effective, by mixing with the acidic dispersion of step b), in bringing the pH of the mixture in the desired range of pH>4.8. In case the pH of the radioactive liquid sewage is low (close to 5) and such that the mixing ratio of the two liquid phases requires too high a volume of radioactive sewage (thus possibly impairing the gelling properties of the overall system), it is possible according to the invention to add a base, for instance NaOH or KOH, to the radioactive sewage or directly into the mixer tank.

The inventor has observed that, working with a radioactive sewage having the composition reported in Table 1 above and density between 1.0 and 1.3 g/cm³, optimal mixing ratios radioactive sewage/silica dispersion are in the range of about 4:1 to 1:1; these ratios allow to obtain final vitreous bodies having a volume that is between about 5% and 15% of the starting liquid mixture, thus optimizing the space occupation in the disposal site.

In step d) of the process, the dense mixture obtained in step c) is dispensed through the outlet nozzle of the mixer tank or mixing device into one or more molds. As described below, the process of the invention foresees natural drying in an oven, and thus the formation of xerogels; since, as explained above, these tend to break into pieces when produced in too big size, the molds employed in this step have preferably a size not exceeding 5 cm in any one of the three spatial directions. The reason for reducing the size of the xerogel in view of obtaining an integer piece is that if the material obtained at the end of the process results broken in fragments, the overall area per unit weight of the material increases, and thus the surface of leaching of radioactive elements and/or isotopes when the final vitreous body is disposed of by burying in special disposal facilities. The molds used in this step may have a cylindrical, cubic, or prismatic shape. The molds are preferably made of plastic, or of metal with the inner surface covered by a layer of polytetrafluoroethylene (PTFE), to ensure easy detachment of the final dry gel from its surfaces. The pH of the dense mixture of step c) ensures the gelling of the silica component of the same in times of between 5 and 30 minutes.

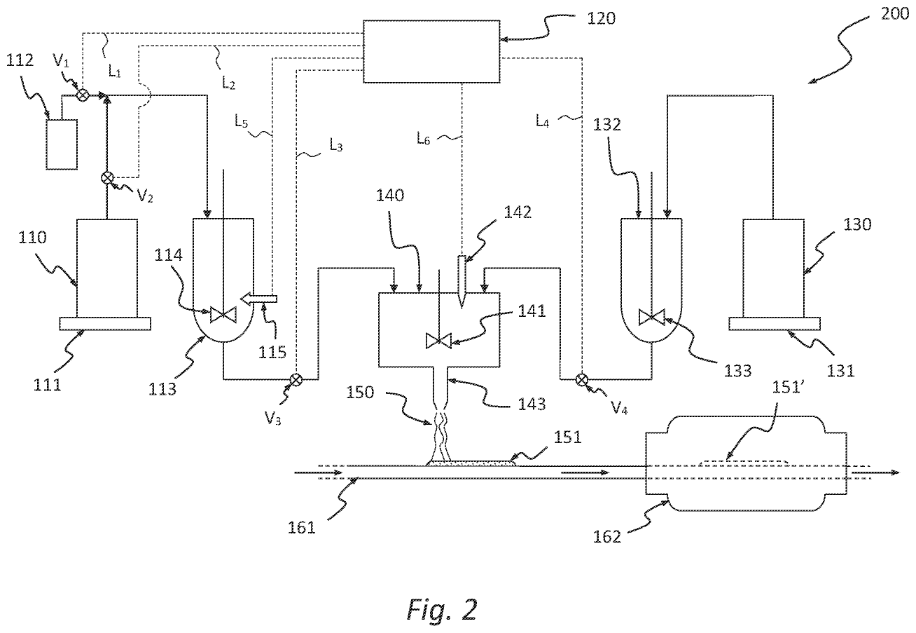

In an alternative embodiment, described more in detail below with reference to FIG. 2, in step d) the dense mixture obtained in step c) is dispensed through the outlet nozzle of the mixer tank onto a flat surface.

Once the mixture in the molds has gelled, these are moved into an oven (preferably a ventilated one) at a temperature between 60 and 70° C. for at least 48 hours in case of mixture dispensed into molds in step d) and between 0.5 and 1 hours in case of mixture dispensed onto a flat surface in step d), to obtain dry xerogels. During this step the gel shrinks in all three dimensions, due to a phenomenon called syneresis, well known in the field of sol-gel, and the volume of the resulting dry gel is approximately between 50% and 75% of the volume of the starting wet gel; this facilitates the detachment of the dry gels from the mold inner walls; the obtained dry gel is porous and has the appearance and consistency of chalk.

Finally, in the last step of the process, f), the dry porous gel bodies obtained in the previous step are densified by treatment at a temperature between 850 and 1350° C., obtaining one or more vitreous bodies consisting of a silica matrix embedding the radioactive elements and/or isotopes. Typical thermal treatment profiles comprise heating ramp rates between 5 and 10° C./min, maintenance at the maximum temperature for a time between 2 and 15 minutes, typically between 4 and 6 minutes, following by cooling, that may be spontaneous or forced through ventilation.

In a variant of the process described above, the overall amount of alkoxysilane used in the reaction may be subdivided into two portions, the first one being added in step b) to the dispersion of silica in water prepared in step a), and the second one added to the radioactive liquid sewage before its mixing in step c) with the dispersion in water of silica.

In another variant of the process, the dispersion of silica in water of step a) and the radioactive liquid sewage are first mixed, and the whole amount of alkoxysilane employed in the reaction is added to the mixture thus obtained.

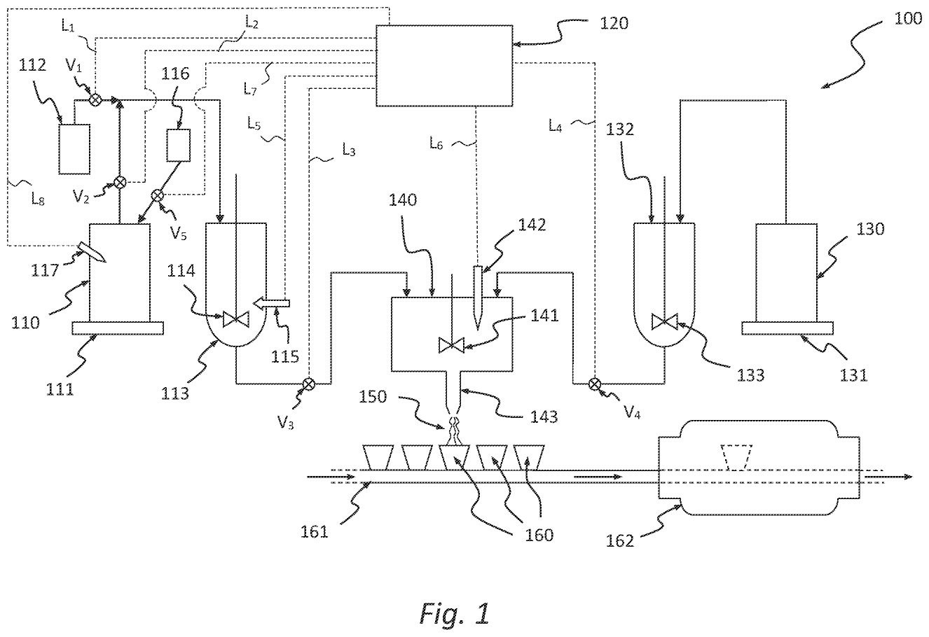

In its second aspect, the invention regards the apparatus for carrying out in an automated way the process described above. Various embodiments of the apparatus are shown schematically in FIGS. 1 to 3; in these figures, to same reference number corresponds the same element.

The apparatus of FIG. 1, 100, comprises a tank 110 for a dispersion of silica in water, positioned on a balance 111, and a reservoir 112 for an alkoxysilane. Tank 110 and reservoir 112 are connected, through pipes, to a tank 113 provided with a mixing device 114, where said dispersion of silica in water and alkoxysilane are mixed in desired ratios; the control of the correct mixing ratio between the dispersion of silica in water and the alkoxysilane is realized by means of a microprocessor (or personal computer) 120 that, through lines L₁ and L₂ controls respectively the degree of opening of valves V₁ and V₂, positioned on the pipes connecting respectively reservoir 112 and tank 110 to tank 113; lines L₁ and L₂, as well as all lines L_{N} mentioned below, are both electric lines for bringing electrical power to the devices/actuators they are connected to, and data lines for transferring information (e.g., temperature, pH, . . . ) to the microprocessor. Apparatus 100 also comprises a tank 116 containing an acid, connected to tank 110 through a line on which a valve V₅ is present, and a pH-meter 117 connected to microprocessor 120 through line L₈. The system constituted by tank 116, pH-meter 117, valve V₅ and lines L₇ and L₈ operates as a feedback loop: microprocessor 120 continuously receives the data about pH in tank 110 and controls the opening of valve V₅ to ensure that the pH in tank 110 is always equal to or lower than 4. The microprocessor 120 is also connected, through line L₅, to thermometer 115 that is immersed in the mixture produced in tank 113.

The apparatus also comprises a reservoir 130 for a radioactive liquid sewage, positioned on a balance 131. Reservoir 130 is connected through a pipe to a tank 132 for said sewage, equipped with a stirrer 133.

In this first embodiment of the apparatus of the invention, the means for mixing the dispersion of silica in water and alkoxysilane and the radioactive liquid sewage, while controlling that the resulting mixture has a preset pH value, are represented by volumetric valves positioned on the pipes connecting tanks 113 and 132 to a mixer tank equipped with a pH-meter, a stirring system and an outlet nozzle.

In detail, tanks 113 and 132 are connected through pipes to a mixer 140 equipped with a stirring system 141, a pH-meter 142 and an outlet nozzle 143. On the pipes connecting tanks 113 and 132 are present volumetric valves, V₃ and V₄ respectively, controlled by microprocessor 120 through lines L₃ and L₄. The microprocessor 120 is also connected, through line L₆, to the pH-meter 142.

In operation, the microprocessor 120 monitors in real time the pH of the mixture formed in mixer 140 by mixing the dispersion coming from tank 113 and the sewage from tank 132, and with a feedback loop regulates the opening of valves V₃ and V₄ in order to keep the pH of the mixture formed in mixer 140 at the desired value (above 4.8).

The dense mixture thus produced in mixer 140 is then dispensed (as indicated by numeral 150 in FIG. 1) through outlet nozzle 143 into molds 160, moved by a conveyor belt 161. The movement of the conveyor belt is synchronized with an element on nozzle 143 that can close the nozzle after a preset period of release of mixture 150, so as to move a new mold under the nozzle when a given volume of mixture has been dispensed into the previous mold. Finally, conveyor belt 161 transports the molds into a ventilated oven 162, where the wet gel formed into the molds is dried at a T of between 60° C. and 70° C.

Finally, the dried gel bodies are vitrified by treatment in an oven (not shown in FIG. 1), that may be any kind of known oven than may reach a temperature of at least 850° C. (for instance, a kiln).

A second embodiment of the invention, apparatus 200, is schematically represented in FIG. 2. For simplicity of representation, in FIG. 2 are not represented tank 116, pH-meter 117, valve V₅ and lines L₇ and L, which are however present in apparatus 200 in the same arrangement as represented in FIG. 1. This second apparatus, 200, does not use molds 160, and the dense mixture 150 is deposited directly onto the conveyor belt 161; the movement of belt 161 produces strips 151 of wet gel, that are then transported by the belt into oven 162 for drying; a gel strip in the oven is represented in figure with dotted lines as element 151′. In this case too, the figure does not show the final vitrification oven.

A third possible embodiment of the apparatus of the invention, apparatus 300, is shown in FIG. 3. For simplicity of representation, in FIG. 3 are not represented tank 116, pH-meter 117, valve V₅ and lines L₇ and L, which are however present in apparatus 200 in the same arrangement as represented in FIG. 1. In this embodiment, mixer 140 of the first and second embodiments is replaced by specific devices performing the same or an equivalent function. In particular, in case the pH values of the water dispersion of silica and hydrolyzed alkoxysilane on one side, and of the radioactive sewage on the other side, are known, the mixer 140 may be replaced by engineered dispensers that integrate the functions of mixer 140 and nozzle 143; since in this case the mixing ratio(s) of the two liquid phases necessary to achieve the condition that the final mixture has pH>4.8 is known, the pH-meter 142 is not necessary and it is sufficient to have a mixer that ensures the control of said mixing ratio. One possible dispenser of this kind is model 2RD12-3D-EC produced and sold by ViscoTec Pumpen-u. Dosiertechnik GmbH (Germany), which achieves a precise and consistent dosing of fluids of different viscosities. In FIG. 3 it is exemplified the case that dense mixture 150 is poured into molds 160, but this could be deposited directly on belt 161 as in FIG. 2: compared to the apparatus of FIG. 1, mixer 140, the separate stirring system 141 and in particular pH-meter 142 and line L₆ connecting the pH-meter to microprocessor 120 are eliminated; similarly, are eliminated valves V₃ and V₄ and lines L₃ and L₄; and two pH-meters 301 and 302 connected to microprocessor 120 respectively through lines L₉ and L₁₀, and mixing device 303, connected to microprocessor 120 through line L₁₁, are added. With this arrangement, microprocessor 120 senses the pH of the liquid phases in tanks 113 and 132, calculates the ratio of flowrates of the two liquid phases that can produce a dense mixture having pH>4.8, and controls device 303 ensuring the production of a dense mixture with the desired pH value. In this case too, the figure does not show the final vitrification oven.

The present invention is further illustrated below by some embodiments provided as non-limiting examples of the extent of the invention.

### Example 1

This example is about a process for of the invention, according to the variant in which the alkoxysilane is added only to a dispersion of silica in water.

In a beaker, 300 g of fumed silica (Aerosil® OX 50) are dispersed in 700 ml of water by using an Ultra-Turrax® mixer, allowing the system to homogenize for an hour. The use of this mixer leads to an increase in temperature that reaches 50° C.; the dispersion is thus allowed to cool down to room temperature before adding other components.

Once the dispersion has reached a temperature of 22° C., its pH is lowered by addition, under vigorous stirring, of 0.57 g of a 1 N aqueous solution of HCl; at the end of the addition the pH reaches a value of 2, as checked with a pH-meter inserted into the reaction beaker.

200 ml are taken from the dispersion thus prepared and placed in a second beaker. 120 ml of TEOS are added to the second beaker, under continuous and vigorous stirring obtained with a magnetic stirrer.

The hydrolysis reaction of TEOS produces an increase in temperature which raises from 20° C. to 34° C. (as measured by the thermometer built into the pH meter) in less than 5 minutes. The temperature remains stable for about 2 minutes, then begins to drop indicating the end of the reaction.

The dispersion is left under stirring for 24 h in the beaker sealed with a polymeric film.

In the meanwhile, Liquid 1 is prepared by diluting with water a radioactive sewage obtained from a nuclear plant waste; Liquid 1 has the following composition:

| Substance | Units | Value |
|---|---|---|
| Total solids | g/kg | 297 |
| Non-dissolved solids | g/kg | 45 |
| Anions (Cl⁻, NO₃⁻, SO₄²⁻, PO₄³⁻) | mmol/kg | 890 |
| Alkali metals (Na⁺, K⁺, Cs⁺) | mmol/kg | 2350 |
| Alkaline earth metals (Ca²⁺, Mg²⁺, Ba²⁺) | mmol/kg | 85 |
| Transition metals (Ti, Cr, Fe, Co, Ni, Cu, Zn, Mo) | mmol/kg | 317 |
| Boron | mmol/kg | 998 |
| Aluminum | mmol/kg | 955 |
| Silicon | mmol/kg | 890 |
| Tin, Lead | mmol/kg | 4 |

Beta/gamma radioactivity (mainly from ⁶⁰Co and ¹³⁷Cs) equal to 3.5×10⁷ Bq/kg.

700 ml of Liquid 1 are homogenized with the Ultra-Turrax® mixer for an hour, then the beaker is left covered and slightly stirred overnight. After 24 hours, the pH of Liquid 1 is checked: the pH-meter indicates a pH of 6.8.

300 ml of dispersion of silica and TEOS are added under stirring to 700 ml of Liquid 1. The resulting mixture appears as a thick liquid, that is quickly poured into 20 cylindrical PTFE molds, each having a volume of 50 ml.

Gelation of the mixture is very fast, and a wet gel is formed in the molds in about 5 minutes. The molds are dried in an oven at 60° C. for 72 hours.

At the end of drying, the xerogels show a volume decrease of about 50%, and are easily extracted from the PTFE molds.

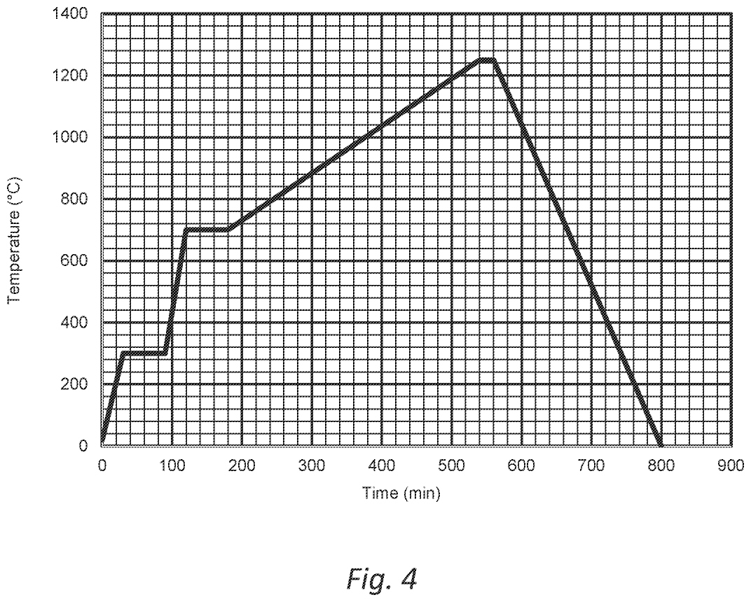

The xerogels are placed on a cristobalite plate (namely, a crystalized quartz plate) and placed in an oven for vitrification according to the thermal profile shown in FIG. 4.

The set of vitrified bodies thus obtained is called Sample 1.

### Example 2

This example is about a process for of the invention, according to the variant in which the alkoxysilane is added partly to a dispersion of silica in water and partly to a radioactive liquid sewage.

250 ml of a dispersion of fumed silica at pH=2, obtained as described in example 1, are added with 210 ml of TEOS under continuous and vigorous stirring.

The hydrolysis reaction of TEOS produces an increase in temperature from the starting value of 23° C. to 37° C. in about 5 minutes. The temperature remains stable about 2 minutes then begins to drop, indicating the end of the reaction.

The dispersion is left under stirring for 24 h in the beaker sealed with a polymeric film.

In the meanwhile, Liquid 2 is prepared in a beaker by diluting with water a radioactive sewage obtained from a nuclear plant waste; Liquid 2 has the following composition:

| Substance | Units | Value |
|---|---|---|
| Total solids | % | 2.5 |
| Anions (F, Cl⁻, NO₃⁻, SO₄²⁻, PO₄³⁻) | mmol/kg | 194 |
| Alkali metals (Na⁺) | mmol/kg | 782 |
| Alkaline earth metals (Ca²⁺) | mmol/kg | 46 |
| Other metals (Cd, Cr, Fe, Co, Ni, Cu, Zn, Pb, Sb) | mmol/kg | 18 |

700 ml of Liquid 2 are homogenized with the Ultra-Turrax® mixer for an hour; the temperature reaches 55° C., and the system is allowed to cool down to room temperature.

When the temperature reaches 23° C., the pH is checked: the pH-meter indicates a pH of 10.8. NaOH is added (a few milligrams) under stirring and under pH control, until a pH value of 11.4 is reached.

2.75 ml of TEOS are added to Liquid 2, under vigorous stirring, and the hydrolysis reaction of TEOS is allowed to take place. Under these conditions (basis catalysis) the hydrolysis reaction of TEOS is slower than with acidic catalysis, and the increase followed by decrease of temperature is not evident; the beaker containing Liquid 2 and TEOS is sealed with a polymeric film and the hydrolysis reaction is allowed to proceed with magnetic stirring for 24 hours.

300 ml of dispersion of silica and hydrolyzed TEOS are added under stirring to 700 ml of Liquid 2 and hydrolyzed TEOS. The resulting mixture appears as a thick liquid, that is quickly poured into 20 cylindrical PTFE molds, each having a volume of 50 ml.

In this case too gelation of the mixture is very fast, and a wet gel is formed in the molds in about 5 minutes.

The molds are placed in an oven to dry at 60° C. for 72 hours.

At the end of drying, the xerogels show a volume decrease of about 50%, and are easily extracted from the PTFE molds.

The xerogels are placed on a cristobalite plate and placed in an oven for vitrification according to the same thermal profile of Example 1 (FIG. 4).

The set of vitrified bodies thus obtained is called Sample 2.

### Example 3

This example is about a process for of the invention, according to the variant in which the alkoxysilane is added to an already prepared mixture of a dispersion of silica in water and a radioactive liquid sewage.

425 ml of Liquid 1 are poured into a beaker. 75 g of fumed silica (Aerosil® OX 50) are added to Liquid 1 and the mixture is homogenized for an hour using an Ultra-Turrax® mixer. During agitation, the temperature rises up to 58° C.

The mixture is allowed to cool with slight stirring and with the beaker covered.

When the temperature of 22° C. is reached, a pH value of 4.8 is measured.

An aqueous solution 1 N of HCl is added under vigorous stirring until pH 2 is reached.

To the mixture thus prepared, 300 ml of TEOS are added.

The reaction of hydrolysis of TEOS brings the temperature to a value of 36° C. in about 10 minutes. The mixture is then allowed to cool overnight under stirring, keeping the beaker sealed with a polymeric film. Maintaining the stirring, the pH is brought to a value of 4.8 by adding dropwise a 1 N aqueous solution of NaOH.

The mixture thus obtained is poured into PTFE cylindric molds; at this pH value, gelation takes place in about 1 h. The molds containing the wet gel are placed in an oven to dry at 60° C. for 72 hours.

At the end of drying, the xerogels show a volume decrease of about 50%, and are easily extracted from the PTFE molds.

The xerogels are placed on a cristobalite plate and placed in an oven for vitrification according to the same thermal profile of Example 1 (FIG. 4).

The set of vitrified bodies thus obtained is called Sample 3.

### Example 4

This example is about a test of release of ions upon contact with water (leaching test) by vitrified bodies obtained with the process of the invention.

One specimen of vitrified body of each of Samples 1, 2 and 3 has been subjected to a leaching test according to standard ENSI-B05, edition December 2018, of the Swiss Federal Nuclear Safety Inspectorate (ENSI).

The release of some metals with time under the test conditions is summarized below, in terms of radioactivity of derived aqueous solutions connected to several isotopes, in Table 1 for Sample 1, in Table 2 for Sample 2 and in Table 3 for Sample 3.

TABLE 1

| Time | Radioactivity of isotopes (Bq) | | |
|---|---|---|---|
| (hours) | ⁶⁰Co | ¹³⁴Cs | ¹³⁷Cs |
| 0 | 20920 | 219 | 3049 |
| 24 | 15.93 | 0.76 | 10 |
| 72 | 105 | 7 | 98.6 |
| 168 | 135 | 8.1 | 106.7 |
| 720 | 153 | 7.4 | 114.6 |
| 1440 | 184 | 9 | 121 |

TABLE 2

| | |
|---|---|
| Time | Radioactivity of isotopes (Bq) |

| (hours) | ⁶⁰Co | ¹²⁵Sb |
|---|---|---|
| 0 | 20920 | 219 |
| 24 | 15.93 | 0.76 |
| 72 | 105 | 7 |
| 168 | 135 | 8.1 |
| 720 | 153 | 7.4 |
| 1440 | 184 | 9 |

TABLE 3

| Time | Radioactivity of isotopes (Bq) | | |
|---|---|---|---|
| (hours) | ⁶⁰Co | ¹³⁴Cs | ¹³⁷Cs |
| 0 | 19879 | 202 | 3101 |
| 24 | 13 | 0.55 | 11 |
| 72 | 98 | 6 | 100.3 |
| 168 | 128 | 7.5 | 107.2 |
| 720 | 147 | 7.6 | 115.4 |
| 1440 | 179 | 8.3 | 123 |

### Example 5

This example is about a mechanical test carried out on samples of the invention. The mechanical resistance of vitrified bodies is important for the foreseen application (burying of these bodies in disposal sites) to ensure that the mechanical stress they can undergo several meters underground do not cause their breaking and the release of fragments with increased mobility and/or increased leaching of radioactive isotopes due to increased surface area. The tests have been carried out according to the procedure fixed by standard ASTM D695-10, which requires a resistance to compression >15 N/mm². The results of the tests are reported in Table 4.

TABLE 4

| | Resistance to compression |
|---|---|
| Sample | (N/mm²) |
| 1 | 29.8 |
| 2 | 33.4 |
| 3 | 36.1 |

1. A sol-gel process for the treatment of radioactive liquid sewage that allows to immobilize radioactive elements and/or isotopes initially present in said sewage in solid vitreous bodies, which comprises the following steps:
a) preparing a dispersion in water of silica in the form of finely subdivided particles, having a size lower than 100 μm, with a silica concentration between 10 and 90% by weight, controlling a pH of the dispersion at a value of 4 or lower by addition of an acid;
b) adding to the dispersion prepared in step a) an alkoxysilane, compound of general formula Si(OR)₄ wherein R is a linear or branched C1-C4 alkyl radical, in a molar ratio alkoxysilane/silica between 0.4 and 0.7, to carry out hydrolysis reaction;
c) at the end of the hydrolysis reaction, feeding the dispersion of step b) to a mixer provided with a stirring system, a pH-meter and an outlet nozzle, along with a radioactive liquid sewage, controlling a radioactive sewage/dispersion mixing ratio to such a value that the resulting mixture has a pH value above 4.8;
d) dispensing the mixture obtained in step c) through the outlet nozzle into one or more molds or on a flat surface;
e) drying the mixture by placing the molds or flat surface containing it in an oven at a temperature of between 60 and 70° C. for a time between 0.5 and 1 hour in case in step d) said mixture is dispensed directly on a flat surface, or for a time of at least 48 hours in case in step d) said mixture is dispensed into molds, obtaining one or more dry porous gel bodies;
f) treating the dry porous gel bodies obtained in step e) at a maximum temperature between 850 and 1350° C., obtaining one or more vitreous bodies consisting of a silica matrix embedding the radioactive elements and/or isotopes.

2. The process according to claim 1, wherein the dispersion prepared in step a) has a content of silica between 20 and 65% by weight.

3. The process according to claim 2, wherein said dispersion has a content of silica between 30 and 40% by weight.

4. The process according to claim 1, wherein the size of the silica particles used in step a) is lower than 10 μm.

5. The process according to claim 4, wherein the size of the silica particles is lower than 5 μm.

6. The process according to claim 1, wherein the dispersion prepared in step a) has a pH value in the range between 1.5 and 3.

7. The process according to claim 6, wherein said pH is in the range between 2 and 2.5.

8. The process according to claim 1, wherein the acid used in step a) is selected among formic acid, acetic acid, hydrochloric acid, nitric acid, phosphoric acid, and sulfuric acid.

9. The process according to claim 1, wherein step a) is carried out at a temperature in the range between 18 and 30° C.

10. The process according to claim 1, wherein in step b) the molar ratio alkoxysilane/silica is between 0.5 and 0.6.

11. The process according to claim 1, wherein the alkoxysilane used in step b) is tetramethylortosilane (Si(OCH₃)₄) or tetraethylortosilane (Si(OCH₂CH₃)₄).

12. The process according to claim 1, wherein in step c) the radioactive sewage/dispersion mixing ratio is in a range from 4:1 to 1:1.

13. The process according to claim 1, wherein in step d) the mixture obtained in step c) is dispensed in molds having a size not exceeding 5 cm in any one of the three spatial directions.

14. The process according to claim 1, wherein step f) is carried out by heating the dry porous gel bodies with a heat ramp of between 5 and 10° C./min, maintaining the maximum temperature for a time between 2 and 15 minutes, and allowing the vitreous bodies thus obtained to cool down to room temperature.

15. An apparatus for carrying out in an automated way the process of claim 1, comprising:
a tank for a dispersion of silica in water, positioned on a balance;
a reservoir for an alkoxysilane;
a tank provided with a mixing device for a mixture of the dispersion of silica in water and the alkoxysilane;
pipes connecting the tank for the dispersion of silica in water and the reservoir for the alkoxysilane to the tank for the mixture of dispersion of silica in water and alkoxysilane;
a volumetric valve V₁ on the pipe connecting the reservoir for the alkoxysilane to the tank for the mixture of dispersion of silica in water and alkoxysilane;
a volumetric valve V₂ on the pipe connecting the tank for the dispersion of silica in water to the tank for the mixture of dispersion of silica in water and alkoxysilane;
a thermometer inserted in the tank for the mixture of dispersion of silica in water and alkoxysilane;
a tank for containing an acid, connected said tank for a dispersion of silica in water through a line on which a valve V₅ is present;
a pH-meter inserted in said tank for a dispersion of silica in water;
a reservoir for a radioactive liquid sewage, positioned on a balance;
a stirred tank for the radioactive liquid sewage;
a pipe connecting the reservoir for the radioactive liquid sewage to the stirred tank for said sewage;
a mixing tank or device for mixing said dispersion of silica in water and alkoxysilane and said radioactive liquid sewage;
a pipe connecting the tank containing the mixture of dispersion of silica in water and alkoxysilane to said mixing tank or device;
a pipe connecting said stirred tank for sewage to said mixing tank or device;
a microprocessor or a personal computer;
means, controlled by said microprocessor or personal computer, for mixing said dispersion of silica in water and alkoxysilane and said radioactive liquid sewage controlling that the resulting mixture has a preset pH value
a line L₁ connecting volumetric valve V₁ to said microprocessor or personal computer;
a line L₂ connecting volumetric valve V₂ to said microprocessor or personal computer;
a line L₅ connecting said thermometer to said microprocessor or personal computer;
a line L₇ connecting said valve V₅ to said microprocessor or personal computer;
a line L₈ connecting said pH-meter to said microprocessor or personal computer;
a conveyor belt for transporting the mixture leaving said mixing tank or device, either in molds or directly on the surface of the belt, in an oven.

16. The apparatus according to claim 15, wherein said means controlled by a microprocessor or personal computer comprise:
a mixer tank provided with a stirring system, a pH-meter and an outlet nozzle;
a volumetric valve V₃ on the pipe connecting the tank containing the mixture of dispersion of silica in water and alkoxysilane to said mixer tank;
a volumetric valve V₄ on the pipe connecting the stirred tank for sewage to the said mixer tank;
a line L₃ connecting said volumetric valve V₃ to said microprocessor or personal computer;
a line L₄ connecting said volumetric valve V₄ to said microprocessor or personal computer;
a line L₆ connecting said pH-meter to said microprocessor or personal computer.

17. The apparatus according to claim 15, wherein said means controlled by a microprocessor or personal computer comprise:
a mixing device provided with an outlet nozzle;
a pH-meter measuring the value of pH in the tank provided with the mixing device for the mixture of the dispersion of silica in water and the alkoxysilane;
a pH-meter measuring the value of pH in the stirred tank for the radioactive liquid sewage;
a line L₉ connecting said pH-meter measuring the value of pH in the tank provided with the mixing device for the mixture of the dispersion of silica in water and the alkoxysilane to said microprocessor or personal computer;
a line L₁₀ connecting said pH-meter measuring the value of pH in the stirred tank for the radioactive liquid sewage to said microprocessor or personal computer;
a line L₁₁ for said mixing device provided with the outlet nozzle to said microprocessor or personal computer.
